(19) United States
(12) Patent Application Publication
(10) Pub. No.: US 2014/0021669 A1
(43) Pub. Date: Jan. 23, 2014

(54) TEST PLATFORM

(71) Applicant: YONG-SHENG YANG, Shenzhen City (CN)

(72) Inventor: YONG-SHENG YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/568,112

(22) Filed: Aug. 6, 2012

(30) Foreign Application Priority Data
Jul. 17, 2012 (CN) 2012102466505

(51) Int. Cl. B23Q 1/64

(52) U.S. Cl. 269/57

(57) ABSTRACT

A test platform includes an annular rail, a supporting member rotatably mounted upon the rail, a number of wheel members mounted on a bottom of the supporting member, and a number of cleaning members mounted on the bottom of the supporting member. Each wheel member includes a wheel capable of rolling along the rail. Each cleaning member includes a cleaning portion rested on the rail. The wheels roll along the rail to rotate the supporting member and the cleaning member. The cleaning portions slide relative to and clean the rail.

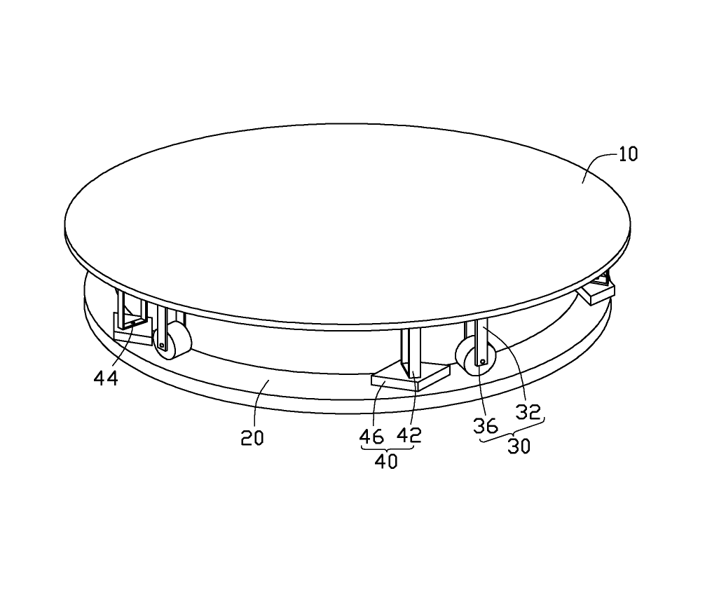

### BACKGROUND

1. Technical Field

The present disclosure relates to a test platform.

2. Description of Related Art

In testing many kinds of electronic equipment, items to be tested may be supported on a round stage. The stage includes a plurality of wheels capable of rolling along a rail so that the stage can be rotated 360 degrees. However, the rail can easily attract dust, and when the wheels roll along the rail, electromagnetic radiation can occur and influence the testing. As a result, the stage needs to be regularly taken apart and cleaned manually, which is inconvenient.

### BRIEF DESCRIPTION OF THE DRAWING

Many aspects of the present embodiments can be better understood with reference to the following drawing. The components in the drawing are not necessarily drawn to scale, the emphasis instead being placed upon clearly illustrating the principles of the present embodiments. Moreover, in the drawing, the view is schematic, and like reference numerals designate corresponding parts throughout the single view.

The FIGURE is an isometric view of an exemplary embodiment of a test platform.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

The FIGURE shows an exemplary embodiment of a test platform. The test platform includes a round supporting member 10, an annular rail 20 located under the supporting member 10, a plurality of wheel members 30 mounted on a bottom of the supporting member 10, and a plurality of cleaning members 40 each mounted on the bottom of the supporting member 10 and beside a corresponding one of the wheel members 30.

Each wheel member 30 includes two arms 32 perpendicularly extending down from the bottom of the supporting member 10 and a wheel 36 rotatably mounted between bottom ends of the arms 32 opposite to the supporting member 10. The wheels 36 are rested on the rail 20 and capable of rolling along the rail 20.

Each cleaning member 40 includes a fixing portion 42 extending down from the bottom of the supporting member 10, and a rhombic cleaning portion 46 sandwiched between the fixing portion 42 and the rail 20. The fixing portion 42 defines a fixing hole 44 in a bottom side opposite to the supporting member 10. A fastener (not shown) extends through the fixing hole 44 and engages in the cleaning portion 46, thereby detachably mounting the cleaning portion 46 to the bottom of the fixing portion 42. In this embodiment, the cleaning portion 46 is made of foam. Opposite ends of one of the diagonals of the cleaning portion 46 are respectively contacted or extended out of inner and outer sides of the rail 20. The length of the one of the diagonals of the cleaning portion 46 is as long as or longer than the width of the rail 20.

In use, the wheels 36 roll along the rail 20, thereby rotating the supporting member 10 and the cleaning members 40. The cleaning portions 46 slide along the rail 20 and clean the dust from the rail 20.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A test platform, comprising:
a rail;
a supporting member;
a plurality of wheel members mounted to a bottom of the supporting member, each wheel member comprising a wheel rested on the rail and capable of rolling along the rail; and
at least one cleaning member each comprising a cleaning portion, the cleaning portion slidably rested on the rail, wherein when the supporting member moves relative to the rail, the at least one cleaning member slides relative to and cleans the rail.

2. The test platform of claim 1, wherein the rail is in annular shape; the at least one cleaning member is mounted at the bottom of the supporting member; and the cleaning portion is rhombic.

3. The test platform of claim 2, wherein opposite ends of one of the diagonals of the cleaning portion are respectively contacted inner and outer sides of the rail.

4. The test platform of claim 3, wherein the cleaning portion is made of foam.

5. The test platform of claim 2, wherein opposite ends of one of the diagonals of the cleaning portion respectively extend out of inner and outer sides of the rail.

6. The test platform of claim 1, wherein each wheel member comprises two arms extending down from the bottom of the supporting member, each wheel is rotatably mounted between bottom ends of the corresponding arms opposite to the supporting member.

7. The test platform of claim 1, wherein the at least one cleaning member further comprises a fixing portion extending from the bottom of the supporting member, the cleaning portion is mounted to a bottom of the fixing portion.

8. The test platform of claim 7, wherein the fixing portion defines a fixing hole in a bottom opposite to the supporting member, the cleaning portion is detachably mounted to the bottom the fixing portion through the fixing hole.
